(19) United States
(12) Patent Application Publication
(10) Pub. No.: US 2006/0273735 A1
(43) Pub. Date: Dec. 7, 2006

(54) Plasma display panel

(76) Inventors: Seung-Hyun Son, Suwon-si (KR); Young-Mo Kim, Suwon-si (KR); Hidekazu Hatanaka, Suwon-si (KR); Sang-Hun Jang, Suwon-si (KR)

Correspondence Address: LEE & MORSE, P.C., 3141 FAIRVIEW PARK DRIVE, SUITE 500, FALLS CHURCH, VA, 22042, US

(21) Appl. No.: 11/435,772

(22) Filed: May 18, 2006

(30) Foreign Application Priority Data
May 19, 2005 (KR) 10-2005-0042170

(51) Int. Cl. G09G 3/10

(52) U.S. Cl. 315/169.1

(57) ABSTRACT

A plasma display panel (PDP) includes a front substrate, a rear substrate facing the front substrate, a plurality of discharge cells between the front and rear substrates, and a plurality of sustain electrode pairs including an X electrode and a Y electrode formed in a predetermined pattern between the front and rear substrates, each discharge cell including at least two sustain discharge element pairs between which sustain discharge may occur.

### BACKGROUND OF THE INVENTION

1. Field of the Invention

The present invention relates to a plasma display panel (PDP). More particularly, the present invention relates to a PDP which includes sustain electrode pairs in unit discharge cells to enable multiple discharges.

2. Description of the Related Art

Plasma display panels (PDPs), which form images through electric discharge, have good brightness and large viewing angles, and are becoming increasingly popular. In PDPs, gas between electrodes is excited by a direct current (DC) voltage or an alternating current (AC) voltage applied to the electrodes, emiting ultraviolet rays during gas discharge to excite phosphors which emit visible light, thus forming an image.

FIG. 1 illustrates a conventional transmissive PDP. FIG. 2 illustrates a cross-sectional view of the PDP of FIG. 1, with a rear substrate 10 and a front substrate 20 of the PDP rotated by 90° with respect to one another for clearer illustration of the internal structure. Here, “front” refers to the direction in which an image is displayed. FIG. 3 illustrates a plan view of sustain electrode pairs 15 along a line III-III of FIG. 2.

Referring to FIGS. 1 and 2, the conventional PDP includes the rear substrate 10 and the front substrate 20 facing each other. A plurality of the sustain electrode pairs 15, including X and Y electrodes 13 and 14, may be arranged in strips on the rear substrate 10, and may be covered by a first dielectric layer 16. A protective layer 19 may be formed on the first dielectric layer 16.

The front substrate 20 is transparent to visible light, and is usually made of glass. Address electrodes 22 that intersect the sustain electrode pairs 15 may be formed on a lower surface of the front substrate 20.

When the address electrodes 22 are on the front substrate 20, they may be made of indium tin oxide (ITO) to transmit visible light. When the sustain electrode pairs 15 are on the rear substrate 10, they do not have to be transparent, and thus, can be made of an opaque conductive material, e.g., metal.

When the address electrodes 22 are made of ITO, which is transparent and conductive, but has relatively high resistance, bus electrodes 24 made of metal with good conductivity may be connected to each of the address electrodes 22 in order to reduce resistance. The bus electrodes 24, together with the address electrodes 22, may be covered by a second dielectric layer 26. Bridges 25 may be formed between and electrically connect the bus electrode 24 and the address electrode 22. The bridges 25 may be formed at regular intervals along the bus electrodes 24.

Referring to FIG. 3, the X electrodes 13 and Y electrodes 14 may be strips which extend parallel to each other, both crossing unit discharge cells which are partitioned by barrier ribs 28. Accordingly, only a single sustain discharge occurs between the X electrodes 13 and the Y electrodes 14 during application of a sustain pulse.

Thus, the conventional transmissive type PDP has the following drawbacks. First, as only one sustain discharge occurs between the X electrodes and Y electrodes of a sustain discharge pair in a unit discharge cell, light emission efficiency is low. Second, if the barrier ribs are too high, the volume of the discharge space increases and the address discharge voltage increases. Third, since only simple discharge occurs in unit discharge cells, multiple minute discharges cannot be realized and fine gradation cannot be expressed easily.

### SUMMARY OF THE INVENTION

The present invention is therefore directed to a transmissive type plasma display panel (PDP), which substantially overcomes one or more of the problems due to the limitations and disadvantages of the related art.

It is therefore a feature of an embodiment of the present invention to provide a transmissive type PDP in which a plurality of sustain electrode pairs including X and Y electrodes having various arrangements are included in each discharge cell to generate multiple discharges.

It is therefore another feature of an embodiment of the present invention to provide a transmissive type PDP having an increased light emitting efficiency.

It is therefore a yet another feature of an embodiment of the present invention to provide a transmissive type PDP having an improved fine gradation display.

At least one of the above and other features and advantages may be realized by providing a plasma display panel (PDP) including a front substrate, a rear substrate facing the front substrate, a plurality of discharge cells between the front and rear substrates, and a plurality of sustain electrode pairs including an X electrode and a Y electrode formed in a predetermined pattern between the front and rear substrates, each discharge cell including at least two sustain discharge element pairs between which sustain discharge may occur.

Each electrode in each sustain electrode pair may generate a discharge in each discharge cell. Two X electrodes and two Y electrodes may form the at least two sustain discharge element pairs. The two X electrodes and the two Y electrodes may be arranged in the following order: X electrode, Y electrode, Y electrode and X electrode or Y electrode, X electrode, X electrode and Y electrode.

The sustain discharge element pair may include discharge portions extending from the X and Y electrodes into each discharge cell. Both sustain discharge elements of the sustain discharge element pairs may be discharge portions extending from the X and Y electrodes into each discharge cell and parallel to one another. The discharge portions may be parallel with the X and Y electrodes, and the PDP may further include respective connecting portions electrically connecting the discharge portions to the X and Y electrodes. The connecting portions may be disposed outside of the discharge cells and the discharge portions may be disposed in the discharge cells. The discharge portions and the connecting portions may be perpendicular to each other. The discharge portions and the X electrode and Y electrodes may form the sustain discharge element pairs.

The PDP may include barrier ribs defining the plurality of discharge cells having a height from about 30 to 100 μm.

### BRIEF DESCRIPTION OF THE DRAWINGS

The above and other features and advantages of the present invention will become more apparent to those of ordinary skill in the art by describing in detail exemplary embodiments thereof with reference to the attached drawings in which:

FIG. 1 illustrates an exploded perspective view of a conventional transmissive type plasma display panel (PDP);

FIG. 2 illustrates a cross-sectional view of the PDP of FIG.1;

FIG. 3 illustrates a plan view of sustain electrode pairs along a line III-III of FIG. 2;

FIG. 4 illustrates an exploded perspective view of a transmissive type PDP according to an embodiment of the present invention;

FIG. 5 illustrates a cross-sectional view of the PDP of FIG. 4;

FIG. 6 illustrates a plan view of sustain electrode pairs along a line VI-VI of FIG. 5;

FIG. 7 illustrates a plan view of sustain electrode pairs according to another embodiment of the present invention;

FIG. 8 illustrates a plan view of sustain electrode pairs according to another embodiment of the present invention; and

FIG. 9 illustrates a plan view of sustain electrode pairs according to another embodiment of the present invention.

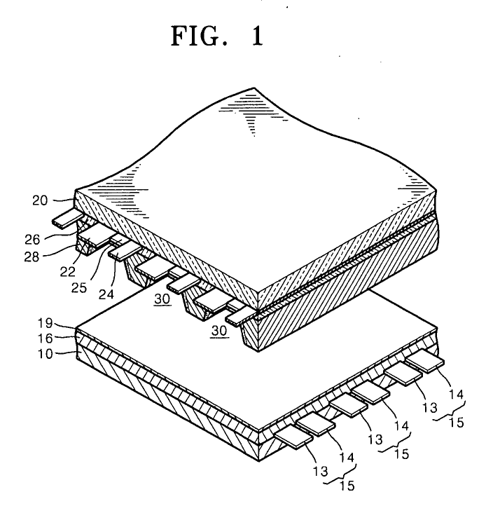

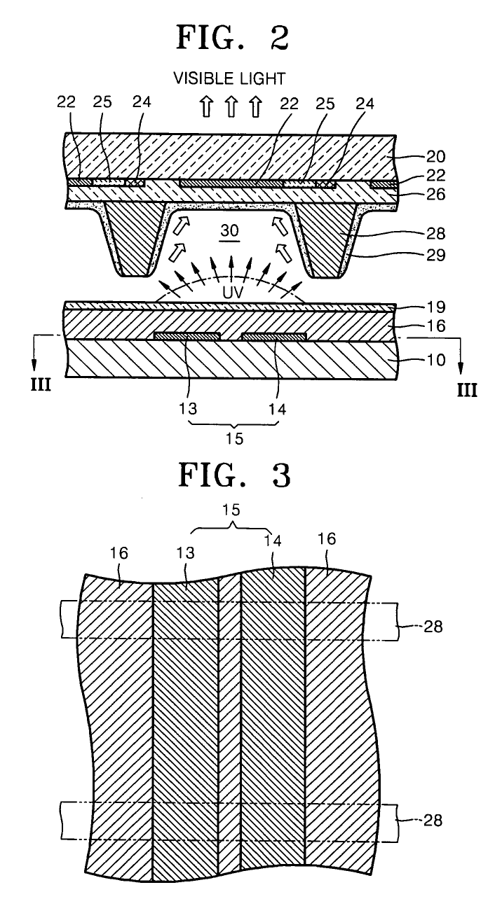

### DETAILED DESCRIPTION OF THE INVENTION

Korean Patent Application No. 10-2005-0042170, filed on May 19, 2005 in the Korean Intellectual Property Office, and entitled: “Transmissive Type Plasma Display Panel,” is incorporated by reference herein in its entirety.

The present invention will now be described more fully hereinafter with reference to the accompanying drawings, in which exemplary embodiments of the invention are shown. The invention may, however, be embodied in different forms and should not be construed as limited to the embodiments set forth herein. Rather, these embodiments are provided so that this disclosure will be thorough and complete, and will fully convey the scope of the invention to those skilled in the art. In the figures, the dimensions of layers and regions are exaggerated for clarity of illustration.

It will also be understood that when a layer is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

As discussed below, a plasma display panel (PDP) may include a plurality of sustain electrode pairs including X and Y electrodes having various arrangements in discharge cells to generate multiple discharge during application of a sustain pulse. While the PDP discussed herein is a transmissive type PDP, the present invention may be employed with other types of PDPs, with the attendant changes in materials, particularly for the electrodes.

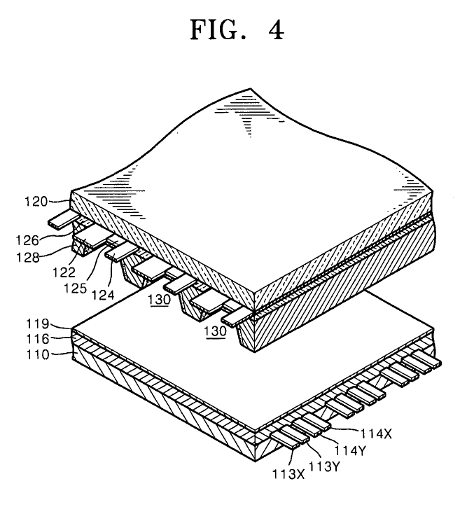

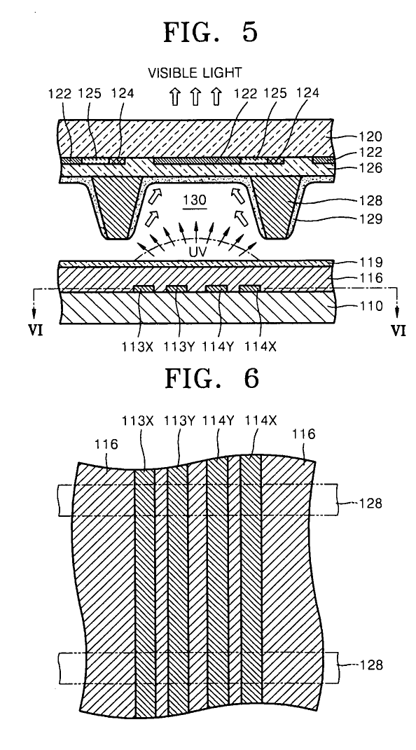

FIG. 4 illustrates an exploded perspective view of a transmissive type PDP according to an embodiment of the present invention. FIG. 5 illustrates a cross-sectional view of the inner structure of the PDP of FIG. 4. In FIG. 5, a front substrate 120 and a rear substrate 110 of the PDP are rotated by 90° relative to one another to more clearly illustrate the inner structure of the PDP.

Referring to FIGS. 4 and 5, the rear substrate 10 of the PDP may include a plurality of sustain electrode pairs 113X and 113Y, and 114X and 114Y in strips arranged in a predetermined pattern. A first dielectric layer 116 may be provided on a top surface of the rear substrate 110 and may cover the sustain electrode pairs. A protective layer 119 may be formed on a top surface of the first dielectric layer 116.

The front substrate 120, which is secured to the rear substrate 110, may include a plurality of address electrodes 122 in strips intersecting the sustain electrode pairs 113X and 113Y, and 14X and 114Y. A second dielectric layer 126 may be formed on a lower surface of the front substrate 120 and may cover the address electrodes 122. A plurality of barrier ribs 128 may be formed on a lower surface of the second dielectric layer 126 and may be disposed at regular intervals to partition discharge cells 130 to prevent electrical and optical interference between the discharge cells 130. A phosphor layer 129 may be provided in the discharge cells 130.

A plurality of the sustain electrode pairs 113X and 113Y, and 114X and 114Y pass through the unit discharge cells, unlike in conventional transmissive type PDPs. That is, in a conventional transmissive type PDP, only one X electrode and one Y electrode of a sustain electrode pair pass through a unit discharge cell, and thus, only a single sustain discharge is generated between the X electrode and the Y electrode in a unit discharge cell. In the present embodiment, however, both sustain electrode pairs 113X and 113Y, and 114X and 114Y pass through the unit discharge cell, not just a single sustain electrode pair.

The PDP in FIGS. 4 and 5 includes two X electrodes and two Y electrodes in each of the unit discharge cells 130. The ends of each pair of the X electrodes 113X and 114X and the ends of each pair of the Y electrodes 113Y and 114Y may be electrically connected at edges of the PDP. The first dielectric layer 116 may be coated on the top surface of the rear substrate 110 to cover the sustain electrode pairs 113X and 113Y, and 114X and 114Y. Accordingly, the sustain electrode pairs 113X and 113Y, and 114X and 114Y are not exposed. The dielectric layer 116 may be formed by, e.g., coating a white dielectric material to a thickness of about 15 to 40 μm on the top surface of the rear substrate 110.

As illustrated in FIG. 5, the protective layer 119 may be formed on a top surface of the dielectric layer 116. The protective layer 119 may prevent damage to the first dielectric layer 116 and the sustain electrode pairs 113X and 113Y, and 114X and 114Y due to sputtering of plasma particles, and may reduce a discharge voltage and a sustain voltage by emitting secondary electrons. The protective layer 119 may be formed by coating MgO to a thickness of about 0.2 to 2.0 μm on the top surface of the dielectric layer 116.

The front substrate 120 is transparent to visible light, and can be made of glass. A discharge gas, e.g., neon, xenon or a mixture thereof, may be injected into the discharge cells 130, and a red, green, or blue phosphor layer 129 may be coated on a lower surface of the second dielectric layer 126 and a lateral surface of the barrier ribs 128 in respective ones of the discharge cells 130.

Due to the multiple discharges that may be realized using the structure according to an embodiment of the present invention, discharge efficiency may be increased. Thus, the barrier ribs 128 partitioning the discharge cells 130 may be short, in order to minimize the volume of the discharge cells 130. The height of the barrier ribs 128 may be about 30 to 100 μm.

The address electrodes 122 on the front substrate 120 may be made of a transparent conductive material, e.g., indium tin oxide (ITO). The sustain electrodes 113X, 113Y, 114X, and 114Y on the rear substrate 110 do not have to be transparent, but may be made of any material having high conductivity, e.g., opaque metal.

When the address electrodes 122 are made of ITO, which is transparent and conductive, but has relatively high resistance, bus electrodes 124 made of metal with good conductivity may be connected to each of the address electrodes 122 in order to reduce resistance. The bus electrodes 124 may be covered by the second dielectric layer 126 together with the address electrodes 122. Bridges 125 may be formed between and electrically connect the bus electrode 24 and the address electrode 122. The bridges 125 may be formed at regular intervals along the bus electrodes 124. Also, so as not to disturb the transmission of the visible light, the bus electrodes 124 may be disposed in a position corresponding to the barrier ribs 128.

FIG. 6 is a plan view of the sustain electrode pairs 113X and 113Y, and 114X and 114Y along line VI-VI of FIG. 5. Referring to FIG. 6, the sustain electrode pairs 113X and 113Y, and 114X and 114Y may be covered by the first dielectric layer 116. The X electrodes 113X and 114X and the Y electrodes 113Y and 114Y forming the sustain electrode pairs may be arranged in each of the discharge cells 130 partitioned by the barrier ribs 128, and, thus, there are two sustain electrode pairs in each of the discharge cells 130.

To generate a desired discharge, the first X electrode 113X, the first Y electrode 113Y, the second Y electrode 114Y and the second X electrode 114X may be sequentially arranged to form sustain electrode pairs. In this manner, sustain discharges may be respectively generated between the pair of the first X and Y electrodes and between the pair of the second X and Y electrodes, while false discharge between X and Y electrodes, which do not form a sustain electrode pair, may be prevented.

In the embodiment illustrated in FIG. 6, the X and Y electrodes 113X and 113Y form a sustain electrode pair in the unit discharge cell 130 and discharge may be generated between the X and Y electrodes 113X and 113Y. Also, the X and Y electrodes 114X and 114Y form a sustain electrode pair and discharge may be generated between the X and Y electrodes 114X and 114Y. Thus, a double sustain discharge may be generated in each of the discharge cells 130 upon application of a sustain pulse.

The driving discharge in the transmissive type PDP according to embodiments of the present invention can be classified into driving for an address discharge and driving for a sustain discharge. The address discharge is generated between the address electrodes 126 formed on the front substrate 120 and any pair of the sustain electrode pairs 113X and 113Y, and 114X and 114Y formed on the rear substrate 110. During address discharge, a wall charge is formed. The sustain discharge is generated by a potential difference between the sustain electrode pair 113X and 113Y or 114X and 114Y disposed in the discharge cells 130 where the wall charge is formed.

The Y electrodes 113Y and 114Y are used for address discharge, and both the Y electrodes 113Y and 114Y and the X electrodes 113X and 114X are used for sustain discharge. Ultraviolet light generated by the discharge gas during the sustain discharge excites the phosphor layer 129 in the corresponding discharge cell 130, and the phosphor layer, in turn, emits visible light. The visible light is transmitted through the front substrate 120 and forms an image.

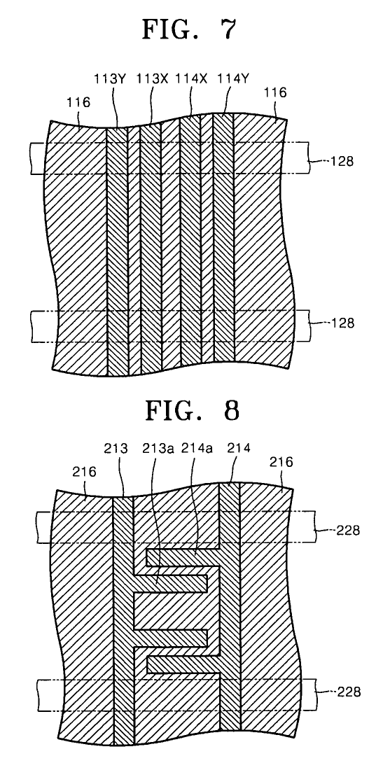

FIG. 7 is a plan view of the sustain electrode pairs 113X and 113Y, and 114X and 114Y according to another embodiment of the present invention. The arrangement of the sustain electrode pairs 113X and 113Y, and 114X and 114Y in FIG. 7 is the same as the arrangement of the sustain electrode pairs 113X and 113Y, and 114X and 114Y in FIG. 6 in that two of the X electrodes 113X and 114Y and two of the Y electrodes 113Y and 114Y are arranged in each of the discharge cells 130 and the X electrodes 113X and 114X and the Y electrodes 113Y and 114Y form pairs. However, the sequence in FIG. 7 is the Y electrode 113Y, the X electrode 113X, the X electrode 114X and a Y electrode 114Y.

The transmissive type PDP according to embodiments of the present invention may include three or more pairs of X and Y electrodes (not shown). That is, when three or more pairs of X and Y electrodes are included, the sustain electrode pairs may be arranged in the following order: Y electrode, X electrode, X electrode, Y electrode, Y electrode and X electrode, or vice versa, in order to prevent false discharges.

FIG. 8 illustrates a plan view of sustain electrodes 213 and 214 according to another embodiment of the present invention. Other than the differences between the sustain electrodes 213 and 214 illustrated in FIG. 8 and the sustain electrodes 113X and 113Y, and 114X and 114Y in FIGS. 4 and 5, the remainder of the PDP for the present embodiment is the same as for the previous embodiment. Accordingly, detailed description of the common elements of these embodiments is not repeated.

In detail, as shown in FIG. 8, each discharge cell 130 may include an X electrode 213 and a Y electrode 214, each electrode respectively having at least two discharge elements 213a and 214a extending therefrom towards the other electrode. The discharge elements 213a and 214a face each other, and form a sustain discharge pair with a predetermined distance therebetween. The predetermined distance between the discharge elements 213a and 214a may be smaller than a spacing between the other electrode and an end of the discharge element. Thus, sustain discharge may be realized between the discharge elements 213a and 214a.

As illustrated in FIG. 8, the discharge elements 213a and 214a may be arranged so as not to overlap the barrier ribs 128, i.e., to be located within the discharge cell 130. The number of sustain discharge element pairs, and, thus an available number of discharges, in each discharge cell can be controlled by controlling the number of discharge elements 213a and 214a. At least two sustain discharge element pairs are provided in each discharge cell 130 to realize multiple discharges. As illustrated in FIG. 8, the discharge elements 213a and 214a may be arranged as 214a, 213a, 213a and 214a.

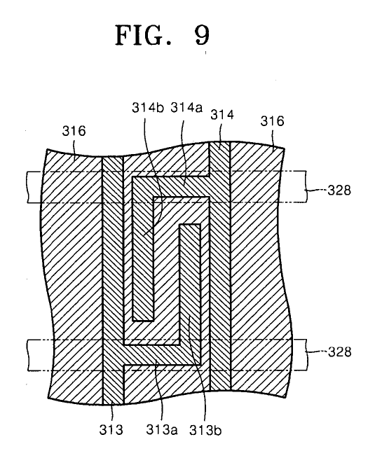

FIG. 9 illustrates a plan view of sustain electrodes 313 and 314 according to another embodiment of the present invention. Other than the differences between the sustain electrodes 313 and 314 illustrated in FIG. 9 and the sustain electrodes 113X and 113Y, and 114X and 114Y in FIGS. 4 and 5, the remainder of the PDP for the present embodiment is the same as for the previous embodiment. Accordingly, detailed description of the common elements of these embodiments is not repeated.

In detail, shown in FIG. 9, each discharge cell 130 may include an X electrode 313 and a Y electrode 314. Each of the X electrode 313 and the Y electrode 314 may respectively include connecting portions 313a and 314a extending therefrom towards the other electrode. The connecting portions 313a and 314a may face each other. Each of the X electrode 313 and the Y electrode 314 may respectively include discharge portions 313b and 314b extending from the connecting portions 313a and 314a, and the discharge portions 313b and 314b may be parallel to one another with a predetermined distance therebetween. The discharge portions 313b and 314b may also be parallel with the X electrode 313 and Y electrode 314. The connecting and discharge portions may be perpendicular to one another.

The discharge portion 313b may be near the Y electrode 314 and the discharge portion 314b may be near the X electrode 313, i.e., closer to the respective X and Y electrodes than to each other. Thus, the discharge portion 313b connected to the X electrode 313 forms a sustain discharge element pair with the Y electrode 314, and the discharge portion 314b connected to the Y electrode 314 forms a sustain discharge element pair with the X electrode 313. The connecting portions 313a and 314a may not be disposed in the discharge cells 130, but may overlap the barrier ribs 128, so that the connecting portions 313a and 314a function only as an electrical path, and do not generate a sustain discharge.

As described above, multiple sustain discharge element pairs may be arranged in various ways in the unit discharge cells to generate multiple sustain discharges. Thus, the transmissive type PDP of the present invention may more precisely express gradation by controlling the number of sustain electrode pairs generating sustain discharge than a conventional transmissive type PDP including only one sustain electrode pair in each discharge cell.

Moreover, the height of barrier ribs in all of the embodiments may be decreased to reduce the volume of the discharge cells, thus reducing the voltage required for the address discharge. In addition, since multiple discharges can occur in each discharge cells, multiple minute discharges can be induced to improve light emitting efficiency and express minute variations in gradation.

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A display panel (PDP), comprising:
a front substrate;
a rear substrate facing the front substrate;
a plurality of discharge cells between the front and rear substrates; and
a plurality of sustain electrode pairs including an X electrode and a Y electrode formed in a predetermined pattern between the front and rear substrates, each discharge cell including at least two sustain discharge element pairs between which sustain discharge may occur.

2. The PDP as claimed in claim 1, wherein each electrode in each sustain electrode pair generates a discharge in each discharge cell.

3. The PDP as claimed in claim 2, wherein two X electrodes and two Y electrodes form the at least two sustain discharge element pairs.

4. The PDP as claimed in claim 3, wherein the two X electrodes and the two Y electrodes are arranged in the following order: X electrode, Y electrode, Y electrode and X electrode.

5. The PDP as claimed in claim 3, wherein the two X electrodes and the two Y electrodes are arranged in the following order: Y electrode, X electrode, X electrode and Y electrode.

6. The PDP as claimed in claim 1, wherein the sustain discharge element pairs include discharge portions extending from the X and Y electrodes into each discharge cell.

7. The PDP as claimed in claim 6, wherein both sustain discharge elements of the sustain discharge element pairs are discharge portions extending from the X and Y electrodes into each discharge cell and are parallel to one another.

8. The PDP as claimed in claim 6, wherein the discharge portions are parallel with the X and Y electrodes, and the PDP further comprises respective connecting portions electrically connecting the discharge portions to the X and Y electrodes.

9. The PDP as claimed in claim 8, wherein the connecting portions are disposed outside of the discharge cells and the discharge portions are disposed in the discharge cells.

10. The PDP as claimed in claim 9, wherein the discharge portions and the connecting portions are perpendicular to each other.

11. The PDP as claimed in claim 8, wherein the discharge portions and the X electrode and Y electrodes form the sustain discharge element pairs.

12. The PDP as claimed in claim 1, further comprising barrier ribs defining the plurality of discharge cells having a height from about 30 to 100 μm.
